(19) United States
(12) Patent Application Publication
(10) Pub. No.: US 2008/0262920 A1
(43) Pub. Date: Oct. 23, 2008

(54) METHODS AND SYSTEMS FOR TRACKING AND ATTRIBUTING ACTIVITIES OF GUEST USERS

(76) Inventors: Sean M. O'Neill, Seattle, WA (US); David P. Repp, Seattle, WA (US); James M. Miller, Sammamish, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/940,286

(22) Filed: Nov. 14, 2007

Related U.S. Application Data
(63) Continuation-in-part of application No. 11/772,033, filed on Jun. 29, 2007.
(60) Provisional application No. 60/915,016, filed on Apr. 30, 2007.
(60) Provisional application No. 60/817,937, filed on Jun. 30, 2006.

(51) Int. Cl. G06Q 30/00; G06Q 10/00

(52) U.S. Cl. 705/14; 705/1; 705/26

(57) ABSTRACT

Systems, methods, and techniques of tracking guest activities are provided. Guests can perform transactions with vendors, for example on behalf of registered participants, which are tracked without needing to register or provide financial or other information specific to the guest to the tracking facilities. Program administrators provide links to registered participants containing a token that identifies the registered participant. These links are then distributed by the registered participants to their designated guests and used for transacting business. Each guest transaction can be anonymously associated back to the proper registered participant through the tokenized link, thereby permitting rewards to be paid to the identified participant based upon associated guest transactions. This abstract is provided to comply with rules requiring an abstract, and it is submitted with the intention that it will not be used to interpret or limit the scope or meaning of the claims.

### TECHNICAL FIELD

The described systems, methods, and techniques pertain to tracking activities and transactions of guest users and, more particularly, to tracking the purchases and other activities of unregistered guests made for the benefit of registered users.

### BACKGROUND

Some existing e-commerce programs allow users to shop at their websites without providing much information or logging in until such user is ready to purchase a good. Thus, users can peruse websites, adding things to an online shopping cart typically until they are ready to “check-out,” thereby consummating a transaction. At that point, they are typically required to give personal information, along with financial information, to identify themselves to the e-commerce site. Many sites, especially those that offer some kind of history information or the ability to track purchases, require such a guest shopper to “join,” “login,” or otherwise create their own registered account. This process of invite and acceptance may create unnecessary delay for the user. In addition, some shoppers may not wish to divulge private information in addition to their minimal payment information.

### BRIEF DESCRIPTION OF THE DRAWINGS

FIG. 1 is an overview flow diagram of an example flow of a participant through an example experiential rewards program.

FIG. 2 is an example block diagram of example components of an example experiential rewards program and interactions between them.

FIG. 3 is an example flow diagram of a process for determining whether a participant is eligible to receive a life-stage reward in an example experiential rewards program.

FIG. 4 is an example block diagram of the components of a system for practicing an experiential rewards program.

FIG. 5 is an example diagram illustrating some of the functions that can be made available to reward programs by one example embodiment of an experiential rewards program system.

FIG. 6 is an example block diagram of a computing system for practicing embodiments of an Experiential Rewards Program System.

FIG. 7 is an example block diagram that illustrates the activities that can occur between an administrator, participants, guests, and vendors in an experiential reward program configured to implement life-stage rewards for married couples.

FIG. 8 is an example block diagram of a computing system architecture for implementing an experiential rewards program.

FIG. 9 is an example block diagram of a computing system architecture for tracking and servicing anonymous guest shoppers.

FIG. 10 is an example overview flow diagram of a process for supporting the anonymous tracking and attributing of online activities conducted by guest users.

### DETAILED DESCRIPTION

Embodiments described herein provide enhanced computer- and network-based methods, techniques, and systems for transparently tracking the online activities of guest users without requiring the guests to register or to provide self-identifying information. Accordingly, such methods, techniques, and systems allow guests to perform online activities and/or behaviors, such as e-commerce transactions as they normally would, however maintaining anonymity with respect to a third party application, service, or service that provides tracking of or otherwise benefits from the guest activity. Such tracking may be used, for example, with commissions-based or other reward or recognition programs that, for example, attribute the activities of the anonymous guests to a designated user registered with the program. For example, guest shoppers who are friends and family of a registered user may be able to shop as they normally do, yet have their activities anonymously attributed to an associated registered user for recognition or reward purposes. Such techniques also allow guests to shop, advertise, and/or perform other activities on behalf of others, without a need to disclose private, identifying information to the programs, methods, or systems that are monitoring such activities on behalf of the others.

Although described herein primarily with regard to “shopping” activities, the described methods, techniques, and systems can be used to more generally track transactions and behaviors associated with online activities. In addition, the tracked activities can be attributed to one or more registered users, who are recognized for these attributions in a variety of ways, including but not limited to: rewarding the registered users with financial or other rewards or distributions, distributing monetary and recognition bonuses, changing the status of the registered user, sign up the registered user for other benefits, for example insurance or health programs, or memberships, supporting a charitable or other cause, etc.

Example embodiments provide methods, techniques, and systems that generate and utilize a tokenized link, e.g., a tokenized Uniform Resource Locator (“URL”) or Uniform Resource Identifier (“URI”) to associate the link with an identified registered user. In an e-commerce environment, the tokenized link can be used, for example, directly by a guest, to shop for goods and services. The tokenized link can be used to automatically cause the activity of the guest to be associated with the registered user, such as a program participant, that is identified by the token. Accordingly, the activities, behaviors, transactions of the guest can be attributed to the identified registered user without the guest needing to register with the e-commerce environment or provide personally-identifying information in order to conduct e-commerce transactions. To perform qualifying activities, the guest need only use the provided tokenized link to conduct the activities. Accordingly, the guest is enabled to perform transactions/activities/behaviors on behalf of the user identified by the URL, which allows, for example, a recognition system to reward or otherwise recognize the identified user transparently to the guest.

In another embodiment, instead of, or in addition to, using tokenized links in the form of URIs, coupons that use existing electronic, bar coding, or scanning technology may be used to embed similar information about a member or registered user and a distinct coupon identifier. Guests can be presented with copies of the coupons, print them out, or put them on an electronic, e.g., mobile device. When presented at a point of sale of a participating vendor or service provider, the coupon code, embodying an association with the member and a unique coupon identifier is forwarded or otherwise used to track the coupon usage activity back to the member or registered user.

In other embodiments, other techniques for transmitting a unique identifier of a transaction vehicle (coupon, link, etc.) along with an identifier of an associated member or registered user can be similarly incorporated. For example, SMS, email messaging, other communications mediums, etc. may be used to associate and transmit appropriate identifiers with the vehicles used to perform activities that may be tracked by some entity, potentially external to the one providing the activity. Such communications mechanisms may be appropriate, for example, to certain types of devices used in performing such activities. For example, SMS messages may be used to convey a tokenized message onto a mobile phone, which can be used by the phone user to conduct activities attributable to a member/user identified by the tokenized message.

In some embodiments, the methods, techniques, and systems are provided to be used within a rewards or recognition program, such as an experiential rewards program described further below. Such embodiments can be used to distribute any kind of reward, recognition, change in status, membership, etc., and are not limited to those used within an experiential rewards program, consumer loyalty program, or the like. In addition, the techniques used to implement such a program can be used by any online activity, application, service, etc. that conducts activities that can be attributed to participants that are registered with the activity, application, service, etc. For example, a magazine publisher may wish to recognize loyal subscribers who promote subscriptions to non-subscribers. Or for example, an online shopping portal may wish to give discounts to registered shoppers for the benefits created through anonymous guest shoppers.

Other examples uses of tracking anonymous guest activities and behavior for the benefit of a member, participant, or registered user include, but are not limited to:
Earning points for a program (a rewards program being one example);
Allowing members to create, print, and distribute electronic coupons for use by guests at participating vendors or service providers;
Credit for purchases that are linked to improving the environment, such as credit for purchases that help a member reduce his or her carbon footprint;
Creation of auxiliary funds for a variety of purposes, including, but not limited to charity, medical bill assistance, insurance premiums, college funding, sponsorships such as an athletic sponsorships, etc.
Funding of a cause such as preservation of a historic building, cleaning up a city park, etc.

According to one such example program, a financial spending commitment is obtained from a participant in the program (a registered user), a commission is received from a vendor based on participant and associated guest spending to purchase vendor goods or services, participant and associated guest spending is monitored (tracked), and rewards from a rewards fund are paid to participants based at least in part on the activities of their associated guests. In other embodiments, other recognitions may be distributed or otherwise attributed to participants. In yet other embodiments, spending commitments are not obtained in advance, and rewards may be generated based upon other metrics, such as the quantity or another quality of goods or services sold.

In some example programs, participants are rewarded and/or recognized based upon their purchases and transactions from one or more vendors as well as the purchases and transactions of their associated guests. In some versions, guests of a participant are not required to register with the system. Instead, participants are provided with one or more tokenized links, which are in turn provided by participants to their guests. Each link identifies the participant so that, when the link is used by the guest to transact for goods or services or for other activities or behaviors, the activity, behavior, or transaction is properly associated with and attributed to the identified participant. In this manner, guests that are associated with the participant can shop or perform other activities on behalf of the participant without having to relinquish self-identifying or accounting information or otherwise identifying themselves to the rewards system. These associated guests may be referred to as “anonymous” guests, because, from the reward program's point of view, the guests can conduct activities without divulging identifying or other guest-specific information.

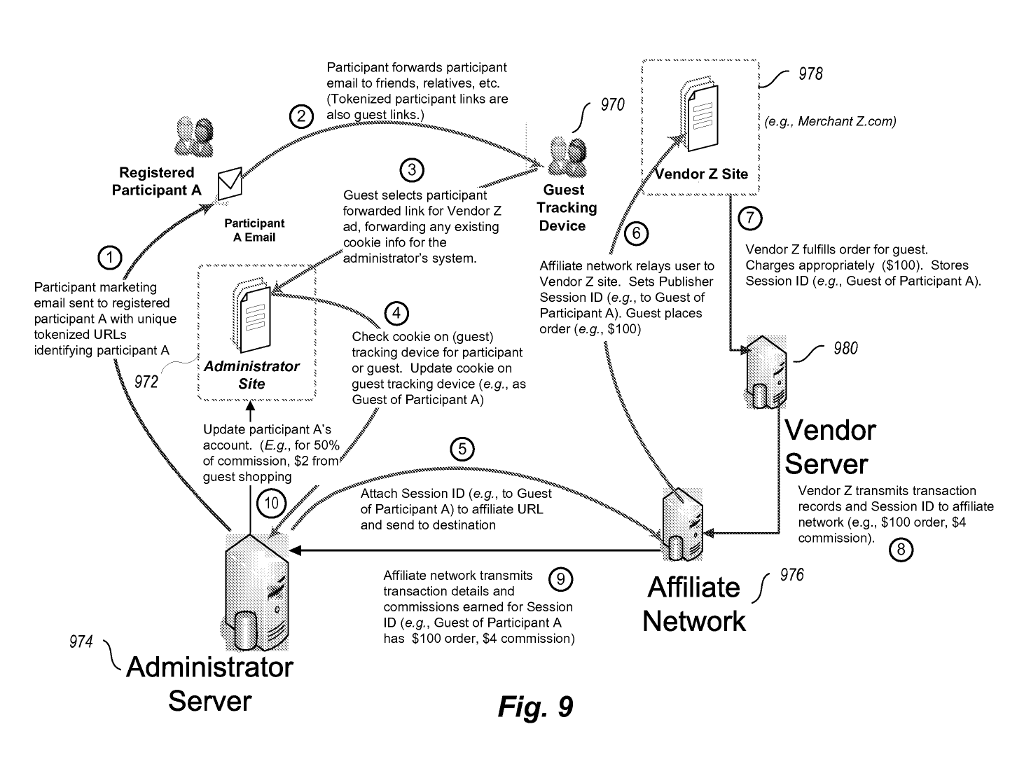

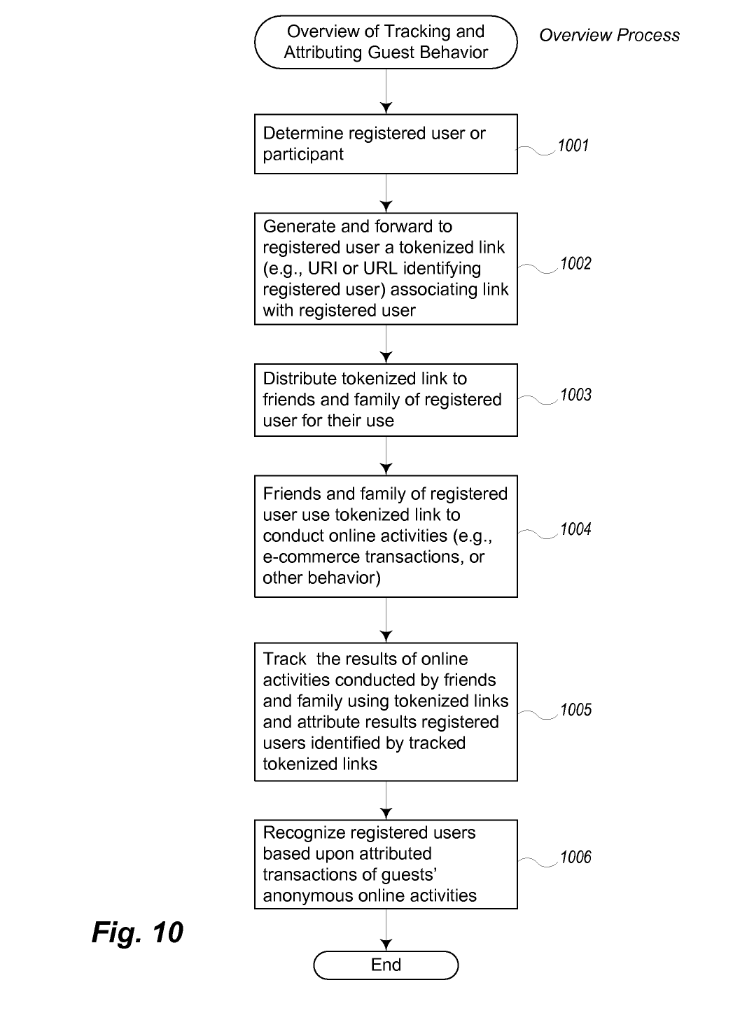

FIG. 10 is an example overview flow diagram of a process for supporting the anonymous tracking and attributing of online activities conducted by guest users. For the purposes of explanation, the phrase “tracking application” is used to describe whatever program, code, application, service, etc. is promoting the use of tokenized links to recognize a participating user. As described above, this may be a rewards program, a charity, an online shopping site, advertiser, etc. In addition, one or more computing systems may be involved to perform one or more of these aspects. An example computing environment for implementing such a program in a loyalty rewards environment is described further below with respect to FIG. 9.

More specifically, in step 1001, the tracking application determines a registered user (or participant) for which to generate links that can be further distributed. In step 1002, the application generates one or more tokenized links specific to the registered user, that can be directly selected by recipients to be redirected to some online activity, such as guest shopping. Each link includes a token that identifies the registered user, and may further provide an indication, direct or indirect to the target activity location. For example, the URL of a merchant site, or an advertiser server for such site, may also be included in the URL. In one embodiment, as shown in step 1002, these tokenized links are distributed to the registered user, in order for them to further distribute the links to desired guests, such as friends and family. This preserves a high degree of anonymity as the tracking application is not made aware of the recipients of the links. In other embodiments, the registered user may provide a list of guests, and the tokenized links forwarded to the guests. These tokenized links may be distributed in many different forms, including for example, email, a portion of a web site designated for the registered user, a document, etc. In addition, these tokenized links may be distributed at different times, and at multiple times.

In step 1003, the tokenized links are distributed to the guests, for example, friends and family of the registered user. As explained, they may be distributed by the registered user, by the tracking application, or by some other entity.

In step 1004, the guests proceed to use the tokenized links to perform online activities and behaviors as directed by the links. For example, the guests may shop for goods, use coupons provided by the links, etc. to perform activities. In step 1005, the results of such activities are automatically and anonymously tracked back to whichever registered user is identified by the link used to perform the activity. In some scenarios, the links are initially received from the guest by the tracking application, which associates account or other registered user information with the guest for the remainder of the activity. The tracking application then relays the link with the further associated information to be used in performance of the transactions by vendors, applications, services, etc. In one such system, described below, the tracking application associates a session identifier with the link, which is associated with an account of the registered user. The tracking application can attribute the results of any performed activity or behavior to the registered user that is associated with the guest, as initiated by use of the tokenized link.

In step 1006, the tracking application (or other third party application that utilizes the tracking application) may provide various forms of recognition to the registered user based at least in part on the results of the anonymous guest online behavior and activities. For example, monetary awards, bonuses, achievement notification, notification of membership or status changes are some of the many types of recognition that may be provided to the registered user.

As mentioned, the above aspects may be used in a variety of environments. In example embodiment embracing these aspects has been implemented to provide systems, methods and techniques for administering rewards programs, such as those used to reward consumer based loyalty. Although the examples provided are described within this context, it is to be understood that the guest tracking mechanisms may be used in other, non rewards oriented embodiments, and for other purposes.

The example rewards systems, methods, and techniques described herein define a unique approach to hard benefit design, referred to herein as an experiential or aspirational reward. This concept embraces the idea of accumulating points for once-in-a-lifetime experiences, premium merchandise, and life-stage or lifestyle themed rewards that appeal to participants' dreams and aspirations. These enhanced value propositions seek to leverage participants' desires for new, value-added, emotional, experiential, unique, and compelling rewards. An arrangement that handles such rewards is referred to herein as an experiential rewards program or an aspirational rewards program.

An experiential rewards program may offer both hard (financial) and soft benefits as an experiential reward. The following elements/aspects can be used individually and in various combinations as part of the design for an experiential reward in such a program:

A. Soft Benefits: These are benefits that provide special access and/or unique privileges for participants as their membership value increases, e.g., as points accumulate. These recognition elements become a significant differentiator as vendors appeal to more affluent, higher-volume, or higher-spending customers. Because such soft benefit rewards are difficult for competitors to duplicate, they are instrumental in reducing churn in vendors' top-tier customer segments.

B. Personalization: Utilizing data from techniques such as data-driven marketing techniques, the systems, methods, and techniques of an experiential rewards program can personalize rewards and communications for vendors and participants, enabling vendors to “operationalize” their Customer Relations Management (CRM) efforts, offering levels of customer service based on a customer's true lifetime value to the bottom line.

C. Leveraging Vendors: In order to avoid reducing vendors' margins and a program administrator's return on investment due to costs associated with design, implementation, and administration of experiential rewards, vendors can be given the ability to leverage their rewards with other vendors to design and help fund an experiential rewards program. For example, a vendor can offer a reward that is becomes worth more to an eligible participant when combined with rewards from other participating vendors. Utilizing a common exchange currency, vendors can establish strategic partnerships that complement their brands, providing natural outlets for their customers' aspirations, and allowing vendors to grow with customers as the present system obtains a greater scope of implementation.

An example of experiential/aspirational rewards offered through the systems, methods, and techniques described herein include life-stage bonuses at sign-up and then at defined periods, such as ten years, twenty years, and thirty years throughout a defined life-stage, such as a couple's marriage. For example, at sign-up a program participant (such as a married couple) may receive a sign-up bonus and a vendor value pack with pre-loaded discounts from program vendors. In addition, participants can qualify to receive a set dollar amount, towards a vacation or second honeymoon. The defined periods for qualifying for rewards may initiate from the beginning of the defined life-stage, some other point in the defined life-stage, from a point before the life-stage, or from some other point in time. In addition, other eligibility criteria may be used to determine aspects of the experiential rewards.

According to one example experiential rewards program, if a participant couple stays married for ten years, stays alive, has continuously met their defined spending targets, has accrued a predetermined number of points and remained statistically eligible by their ten-year wedding anniversary, they can qualify for a “Life-Stage” cash reward (a specific reward based upon certain life stage events). If a participant couple stays married for twenty years, stays alive, has continuously met their defined spending targets, has accrued a predetermined number of points and remained statistically eligible by their twenty-year wedding anniversary, they can qualify for another Life-Stage cash reward. As noted above, in some programs, the anniversaries are computed relative to when the participant couple began participation in the rewards program (such as at the 33^{rd} wedding anniversary, if a newlywed couple did not join until year three of their marriage). Also, in some forms of the rewards program, the Life-Stage cash rewards are determined ahead of time, for example, by the participant obligating themselves to a reward plan upon program registration. The choice of the reward plan may then dictate a required minimum spending commitment. In some forms, a participant may opt to change their reward plan at a future time, for example, upon allocation of the first Life-Stage reward. Although typically the reward payout levels may be increased, they also may be changed in other manners.

In addition to the foregoing Life-Stage or other defined life-stage rewards, the administrator of the program may give a percentage of its membership base a down payment for a new home. The program may also provide annual anniversary rewards based on participating couples achieving their average annual defined spending commitment with participating vendors. Also, if a participant couple stays married for thirty years, stays alive, has continuously met their defined spending targets, has accrued a predetermined number of points and remained statistically eligible by their thirty-year wedding anniversary they can qualify for yet another Life-Stage cash reward. Other rewards also can be defined by the rewards program.

As mentioned, eligibility for the Life-Stage rewards is in part based upon the participant meeting their (explicit or inferred) spending commitment. As merchandise is purchased or services used points are accumulated. In one example rewards program, these points may be earned sooner than the designated time period (such as starting before the participant is eligible to receive a life stage reward). Also, in one example rewards program, points may be earned based upon goods or services purchased or used or based upon other transactions by guests for the benefit of the participant. Accordingly, in these programs guests can assist an associated participant in meeting their spending commitment. Also, once earned the points are not converted to rewards—the points continue to accumulate even after rewards are distributed. (Other arrangements, where points are converted also may be supported in other reward programs.) Thus, rewards, such as interim rewards, that may be in part computed based upon accumulated points so far, may vary between participants. Also, in some forms of the program, users may not yet be eligible to register as eligible participants, but they may still be able to “pre-load” their account to accumulate points.

In one incarnation, the program is designed particularly for engaged and newlywed couples. Proof of marriage may be required from all newlywed couples, such as a valid marriage certificate or other verification means defined by the program administrator. These participants will be issued a “device” that verifies their membership, registers existing credit and debit cards, and provides credit. Such a device can be an apparatus or mechanism such as a well-known credit card (e.g., a co-branded credit card), debit card, program ID card, or other appropriate device, which may be issued by the program administrator or its bank card issuing partner or both.

Engaged and newlywed couples fill out an initial membership application, potentially online, identifying the vendors from whom they currently buy goods and services. This information is used by the program administrator to establish a baseline of vendors for each participating couple. In addition, this information can be used to build a “loyalty factor” rating over the course of the program. Qualifying participants then receive a certain number of points for every qualifying dollar they and their guests spend with participating vendors in the program.

For vendors, the ability to deepen customer loyalty is important because just getting customers is not enough to sustain growth. With the systems, methods, and techniques described herein, program vendors have the ability to create direct marketing campaigns, offer point-of-purchase materials in the context of the program, conduct educational and other activities, as well as receive ongoing business analytical reports to help vendors assess the over-all and ongoing success of the program. These systems, methods, and techniques provide the program vendors the opportunity to examine each phase of the customer lifecycle for loyalty-building opportunities, including identifying service and product elements that are of value to program participants and establishing exit barriers so that the perceived cost of switching brands dissuades program participants from doing so.

Embodiments of an experiential rewards program allow program vendors to cooperate with each other through a coalition. Two or more primary vendors can share a mechanism by which they agree to “cross-sell” or otherwise share program participants in order for them to earn a common promotional currency. The redemption offers are valued in the same currency through program points that may be redeemed for the program vendors' products, or they may be redeemed for something entirely different. Importantly, program vendors can thereby share their customer bases to achieve a common goal.

A coalition based, experiential rewards program is attractive to program participants, because the relative point earning ability of the participant with respect to other (non-coalition) loyalty programs allows each participant to earn a much greater reward value per year. Management of a coalition based program is independent of any one of the vendors, because the vendors have contracts with the program administrator to issue or redeem the currency of the program. In addition, in one embodiment the vendors preferably only have access to data harvested by the program through a program administrator.

In order to implement an experiential rewards program that can achieve a high degree of success, an administrator of such a program should be first in the market, build new communication channels, achieve rapid market penetration, and deliver attractive and compelling rewards. The ability to do so is driven largely by two factors: (1) that the program participant can collect value from market leading companies across all major sectors, including banking, fuel, supermarket, convenience stores, telecommunications, restaurants, clothes, books, CDs, and others; and (2) that the reward to be offered can be purchased at around 50% of its perceived value, with the benefit being passed on to the program participant (in contrast to competing merchants that run programs that usually buy rewards at about a 10%-20% discount from their perceived value, with the discount often not being passed to the consumer). In an experiential rewards program, these characteristics are achieved in several ways. First, the program employs demographic targeting that uses statistical modeling to define eligibility requirements for the program so that not every participant will hit the defined life-stage periods. Combined with the requirement to hit the defined spending requirements (based upon the commitment level chosen), only a select number of participants will beat the odds and receive the extraordinary life-stage rewards. Thus, demographics such as longevity of marriages, along with computed probabilities that certain events will or will not occur can define reward levels and spending commitment criteria for the program.

A number of factors may be important in establishing a successful experiential rewards program, including obtaining relevant information on the maximum number of customers in a desired target market group; gathering data on demographic, social-economic, lifestyle, and transactional information; developing channels of communications direct to the program participant that are highly cost-effective relative to competitors; and developing barriers to entry that will effectively block competitors from copying an initiative.

Some of an experiential rewards program's strengths over existing programs may include increased interest in the program, fewer cards for program participants to carry, quick point accumulation, the ability to increase accumulation through anonymous guest shoppers (associated with a participant) at little risk to the guest, greater variety of significant cash rewards, concentrated and coherent promotions, lower costs and time savings in development, professionally-run databases, sector exclusivity, coalition marketing campaigns, high penetration, and real cost benefits. Other advantages are possible.

A coalition thus formed through an experiential rewards program can offer personalization, build emotional ties, and provide significant benefits to its vendors and participants. Such a program can offer program vendors mass customization opportunities to create targeted messages that speak directly to their best customers and address their specific needs. It can also create an emotional tie by making program vendor rewards interactive, timely, and exclusive. Using a combination of hard and soft benefits, such programs can provide financial benefits as well as the soft benefits of recognition and communication with program participants. Thus, experiential rewards programs implemented using the systems, methods, and techniques described provide reduced costs to program vendors and enhanced value propositions. Vendors will end up paying a fraction of the costs that would otherwise be associated with running their own programs, because the vendors will not need to send out direct mails, buy lists, and run ads.

In addition, program participants are likely to increase their loyalty to the program, because they can accrue more value more quickly and receive very large cash life-stage rewards, and only need to have one loyalty card. They do not have to rely on only one provider's products or services to earn points. Moreover, they do not have to rely on only their own purchases—their friends and family can help them accrue more value through anonymous guest shopping. Thus, using the techniques, methods, and systems of an experiential rewards program, traditional loyalty programs, such as those offered by supermarkets, gas stations, travel operators, financial institutions, telecommunications and internet service providers, hotels, and rental car companies, can all be made available to program participants through a single program and a single card.

Also, a program administrator may utilize a predictive statistical model to establish and qualify continued eligibility of program participants. More specifically, data, such as purchase data coupled with demographic and other statistical data may be used in the predictive model to forecast purchasing probabilities and trends, validate or revise forecasts, and to cooperate with program vendors in marketing of the goods and services. In addition, the data may be used to manage a rewards fund.

In some embodiments, an experiential rewards program is provided that rewards program participants for purchasing a defined amount of products or services from participating vendors and that motivates program participants to meet defined purchase amounts in order to obtain a defined reward. This experiential rewards program also motivates program participants to drive viral marketing by encouraging friends and family to purchase from participating vendors as anonymous guest shoppers. (Again, anonymous refers to anonymity regarding identification of the guest to the rewards program.) Program vendors may pay commissions to the program administrator in return for participant and associated guest purchases of products or services from the program vendors.

In one example embodiment (referred to herein as “uTANGO”), a defined experiential rewards program that ideally provides a retirement component is offered exclusively to married couples, and in particular engaged and newlywed couples. The newlyweds commit to a certain level of spending (for example by opting into a particular reward level plan), which is monitored by vendors and the program administrator, and rewards are paid out from a rewards fund to the program participants at defined stages. Such defined stages could be, for example, a period of staying married, reaching a particular age, or spending a predefined amount of money, or any combination of the foregoing. Program vendors pay a commission to the program administrator, for example, based on a defined purchasing level of program participants and potentially the activity level of anonymous guests. The administrator utilizes these funds in whole or in part to establish a rewards fund from which the life-stage rewards are paid out to eligible participants.

Example embodiments described herein provide applications, tools, data structures and other support to implement an experiential rewards program such as the uTANGO program described above for married couples. In the following description, numerous specific details are set forth, such as program components, data formats and flow or code sequences, etc., in order to provide a thorough understanding of the described methods, systems, and techniques. The embodiments described also can be practiced without some of the specific details described herein, or with other specific details, such as changes with respect to the ordering of the flow, different flows, etc. Thus, the scope of the techniques and/or functions described are not limited by the particular order, selection, or decomposition of steps or acts described with reference to any particular flow or block diagram.

Also, although certain terms are used primarily herein, other terms could be used interchangeably to yield equivalent embodiments and examples. For example, it is well-known that equivalent terms could be substituted for such terms as “rewards,” “incentives,” “CRM,” “loyalty,” “anonymous,” “guest,” “link,” “token,” “affiliate,” etc. In addition, terms may have alternate spellings which may or may not be explicitly mentioned, and all such variations of terms are intended to be included.

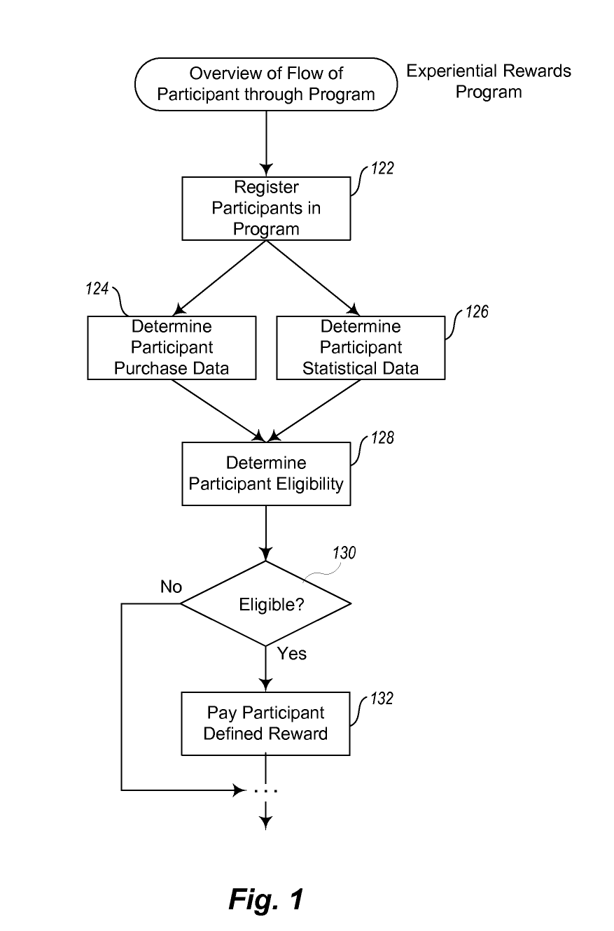

FIG. 1 is an overview flow diagram of an example flow of a participant through an example experiential rewards program. In FIG. 1, program participants are initially registered (step 122) in the program. As part of the registration process, participants provide personal information from which participants' statistical data are derived (step 126). Participating vendors (potentially through transaction processing mechanisms) provide participants' associated purchase data (step 124). The purchase data may be based upon participants' purchases as well as purchases made on behalf of participants, such as by guests. Utilizing the purchase data and statistical data, the participants' eligibility is determined (step 128), including eligibility to participate in the program and eligibility for rewards at various times as defined by the program. If the participant is determined to be eligible (step 130), then, at appropriate times as determined by the program, the participant is then paid a defined reward (step 132) or is given other options as appropriate (such as deferral of the reward). If the participant is not eligible, then the rewards program processes that participant, for example, notifying the participant that the participant is no longer eligible. The rewards program then continues processing for other participants as they move through the various stages of steps 122-132.

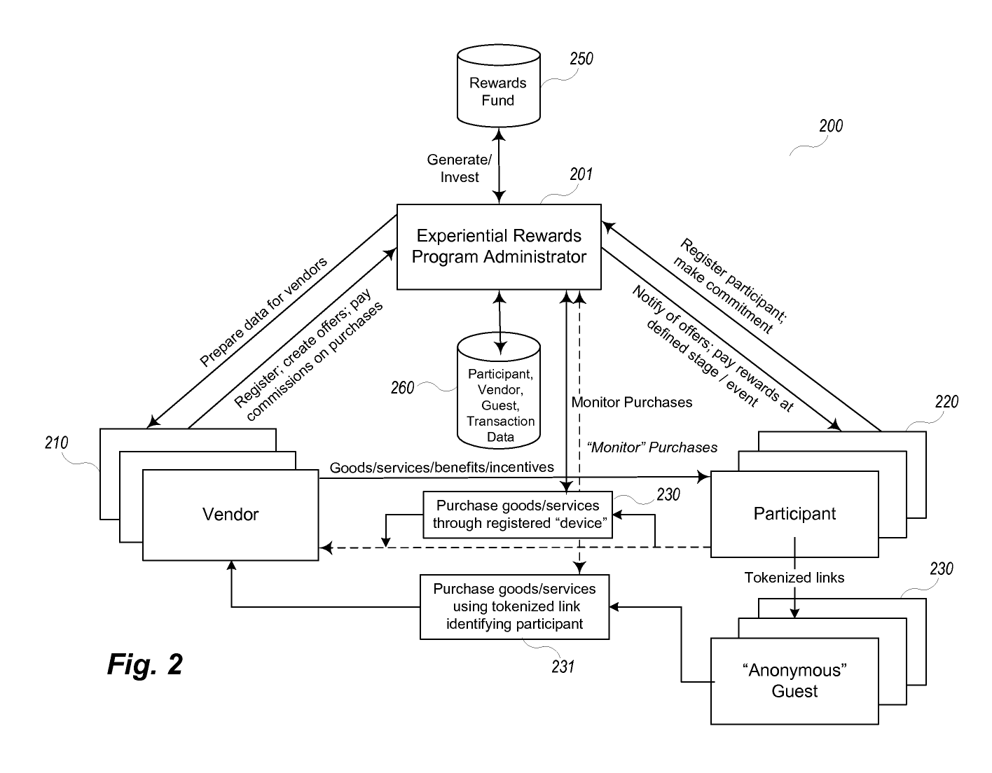

FIG. 2 is an example block diagram of example components of an example experiential rewards program and interactions between them. In FIG. 2, an experiential rewards program administrator 201 (through a system, methods, or techniques) interacts with one or more vendors 210, one or more participants 220, and one or more guests 230 to achieve an example experiential rewards program 200. The experiential rewards program administrator 201 (“ERPA”) creates, maintains, and manages one or more rewards funds 250 for administering life-stage or life-cycle rewards as described herein. In some embodiments, the rewards fund 250 is part of a system or environment administered by the ERPA 201. The rewards fund 250, may, however, be administered or managed by a third party, such as a financial or investment institution, or a vendor, etc. The ERPA 201 also creates, maintains, and manages participant and vendor data 260, which is used by the ERPA 201 to perform statistical analysis for distribution to the vendors 210. Vendors 210 define offers, which are communicated to the participants 220 through the ERPA 201.

Participants 220 purchase goods and services from one or more of the vendors 210, for example, using a registered device 230, such as a co-branded credit card. Purchases made through the registered device 230 can be monitored by the ERPA 201, and the vendors 210. In some embodiments, purchases by participants 220 are made through other mechanisms, and other tracking means (other than through a credit/debit card) are used to monitor purchases. For example, purchases may be made on location at a vendor's physical store and reported separately to the ERPA 201.

Guests 230 can also purchase goods and services from one or more of the vendors 210 on behalf of one or more participants 220. The ERPA 201 causes one or more tokenized links that identify a one of the participants 220 to be sent to the participant. The participant 220 then distributes the one or more tokenized links to one or more guests 230, who can use the distributed links “anonymously” to purchase goods or services on behalf of the participant identified by the tokenized link, without registering with the ERPA 201 or otherwise providing guest-specific information. The purchases, potentially transacted through an unregistered device 231, are also credited to the participant based upon the tokenized link. The ERPA 201 may optionally “monitor” such purchases in order to provide additional identifying information, but treats each guest purchase as an anonymous purchase on behalf of the identified participant 220. Purchases may be made on location at a vendor's physical store and reported separately to the ERPA 201 using other mechanisms.

In typical operation, the ERPA registers a participant 220 and obtains a commitment, such as a commitment to spend a particular amount buying goods or services from one or more vendors 210 over a defined period of time. These commitments are importantly made prior to becoming eligible for rewards, so that they represent an obligation, pledge, or promise made by the participant. Failure to meet the commitment (for example, after a certain period of time) may result lack of eligibility for the program or for a particular life-stage reward. For example, a participant may make a spending commitment, such as a commitment to purchase some dollar amount of goods from the participating vendors, at sign-up. Some times, this commitment can be implied from the participant's selection of a particular reward plan, with pre-designated rewards to be paid out at the various pre-defined life stages. Other combinations are supported.

In one embodiment, the ERPA 201 registers vendors 210 prior to or concurrent with the registration of participants 220. These vendors contract with the ERPA 201 to meet vendor requirements of the administered program. In some embodiments, the vendors 210 pay a commission to the ERPA 201 upon registration, in some cases commensurate with projected data analyzed from the participant, vendor, and transaction data stored in one or more data repositories 260. Such analysis may be performed, for example, using a predictive statistical model.

When a participant 220 initiates a purchase transaction through a registered device 230, the purchase is monitored (directly or indirectly) by the ERPA 201. Accordingly, commissions are received by the administrator 201 from the vendors 210. Commissions can be based wholly or in part on participant purchases. In addition, when an anonymous guest 230 initiates a purchase transaction through an unregistered device 231, the purchase is accredited to the participant 220, by commissions being paid from the vendors 210 to the administrator 201 based upon the information contained in the link used to effectuate the purchase. The ERPA 201 generates or invests in a rewards fund 250, using at least a portion of the received commissions. These funds may be used to pay rewards to the participants 220 at defined life-stage or life-cycle events, such as after 10 years of marriage (and after 10 years of program participation, whichever is later) providing the participants 220 meet the other program eligibility criteria, such as meeting spending and/or loyalty commitments. The ERPA 201 calculates participant eligibility typically based upon statistical data as well as purchase data from the monitored purchases as tracked in a data repository 260. A defined reward is then paid by the ERPA 201 to qualified participants 220, preferably at a defined stage. Examples of a defined reward include, but are not limited to, a fixed dollar amount, a privilege, or goods or services of value to the participants, or any combination of the foregoing. The rewards are distributed at defined periods or stages, such as a particular length of marriage, age, etc.

Data from the one or more data repositories 260 may be shared, in whole or in part, with the previously registered vendors 210. For example, purchasing trends of the participants 220 and their associated guests 230 can be transmitted to the vendors 210 electronically or made available to the vendors 210 via secure access, for example over a network such as the Internet.

In some embodiments of an experiential rewards program, the process of rewarding spending and loyalty includes generating and potentially continuing to fund a rewards fund from commissions received from program vendors for sales to program participants, and then paying qualified participants a reward from the rewards fund at defined periods or stages. Eligibility for a reward may be based on a participant meeting the requirements for each reward, including, but not limited to, one or more of: meeting a defined spending level in accordance with a prior commitment, reaching a defined life-stage such as defined wedding anniversaries, and other life-stage periods.

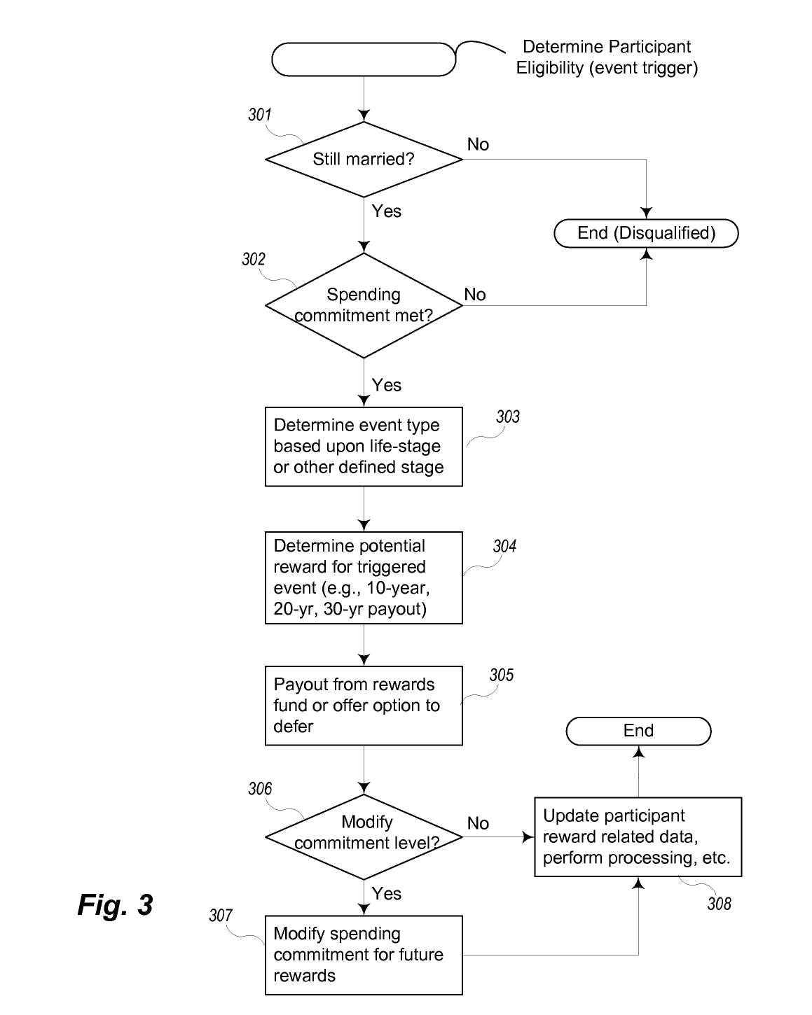

FIG. 3 is an example flow diagram of a process for determining whether a participant is eligible to receive a life-stage reward in an example experiential rewards program. The process of FIG. 3 may be performed, for example, by one or more computing systems executing instructions to support an administrator (such as the ERPA 201 of FIG. 2) to administer program-defined rewards at defined periods or stages. The process first determines whether a designated participant is still eligible to receive the designated life-stage award. For example, in a program designed to reward participants based upon a spending commitment and loyalty to a marriage, in steps 301 and 302, the process determines whether the participant is still married (step 301) and whether the participant has met their spending commitment (step 302). If either of these tests fail, the participant is disqualified. Next, the process determines what kind of reward the participant has qualified for based upon a designated event type (step 303). The reward amounts may be predefined when the program administrator sets up a particular rewards program, and in some cases, may be modifiable based upon other criteria such as amount of vendor participation in the rewards program. The process then determines the particular potential reward for the designated participant, such as based upon the participant's points in the rewards program accrued thus far (step 304). The participant can then opt to receive the determined payout or, in some programs, defer the payout to invest towards the next defined stage payout (step 305). If the program offers an ability for a participant to modify their spending commitment at that point, the process then receives an indication of whether the participant wishes to do so (step 306), and, if so, modifies the commitment for future reward requirements (step 307), otherwise continues. The process then updates the participant's data (step 308) to reflect the reward status, performs other processing as indicated, and ends.

The acts of registering participants (see, e.g., step 122 in FIG. 1) and determining participant eligibility (see, e.g., step 128 in FIG. 1) may be specific to a particular rewards program. For example, with reference to the example experiential rewards program uTANGO (for newly married couples), engaged or newlywed couples are permitted to join the program through a registration process made available by a program administrator. In one embodiment, the registration process is available via a web portal accessible from a web browser or other client application. Upon registration, engaged and newlywed couples select which defined “Life-Stage Rewards Plan” they wish to commit to and, in doing so, establish their defined payout amounts and set their defined spending targets with various program vendors. Participants also establish the date they plan to get married or when they were married. Other data may also be collected by the program administrator as appropriate.

In one form of the uTANGO rewards program, the program requires that engaged and newlywed couples join the uTANGO program prior to the end of three years of marriage (other defined periods can also be supported). Upon registration, a participant couple selects a defined Life-Stage Reward Plan that establishes their annual defined spending commitment to the program. For example, in one embodiment, three plans are offered for $250,000, $500,000, $1,000,000, respectively, which pays out rewards (potentially minimally) at those amounts at a 30-Year Life-Stage Reward when certain annual spending targets are also met and the couple remains married. The spending targets may vary respectively with each plan. In this particular form of the program, participants must average a specific level of spending over defined periods and cannot miss back-to-back years of hitting their spending target, otherwise they risk disqualification. Other programs and forms of the same program can implement different qualification criteria as desired, including different periods for missing spending targets, different defined levels of spending, differing opportunities for changing a spending commitment, etc. At the 10-year mark, participating couples can select several options: (1) they can choose to receive or “defer” their 10-year payout, and, if deferred, the program administrator will add a substantial cash bonus to their 20- or 30-year (or both) Life-Stage Payout, and (2) they can chose to step up to a higher value Life-Stage Rewards Plan for future payouts. If they do chose to step up, they become committed to the spending levels of the new plan and will receive the increase Life-Stage reward payouts, but they cannot drop back down to a lower level plan once they have chosen to step up. Other options are also possible. Note as well that the defined periods or stages, such as the 10-year mark, may be computed differently for different programs, for example, from registration in the program as a newlywed of 3 years instead of at the actual 10-year marriage anniversary mark.

Depending upon the particular program implementation, life-stage rewards can be paid out according to multiple methods, such as a pre-loaded debit card or stored-value card equal to the reward value of the specific reward, as an annuity payment over a defined period of time, as an all cash payment, or as a credit towards merchandise with program vendors. According to one form of the uTANGO program, if a participating spouse dies within the first 15 years of the program, the couple is disqualified to receive their 20-year and 30-year Life-Stage payout. If a participating spouse dies after 15 years (e.g., 15 years and one day), the remaining spouse can stay in the program, spend half of what they originally committed to spend as a couple, and receive half the reward payout at 20 years and 30 years. If the couple divorces at any point in the program, they are automatically disqualified. Other combinations and qualification definitions are possible.

In one embodiment of the uTANGO program, singles and engaged persons can join the uTANGO rewards program to begin accruing points for the future (effectuating “endowed progress” towards a future reward). Then, when such persons become eligible, for example, by becoming married, staying married for the predefined amount of time, and meeting their spending commitments, they can receive life stage and life-style rewards such as those described above.

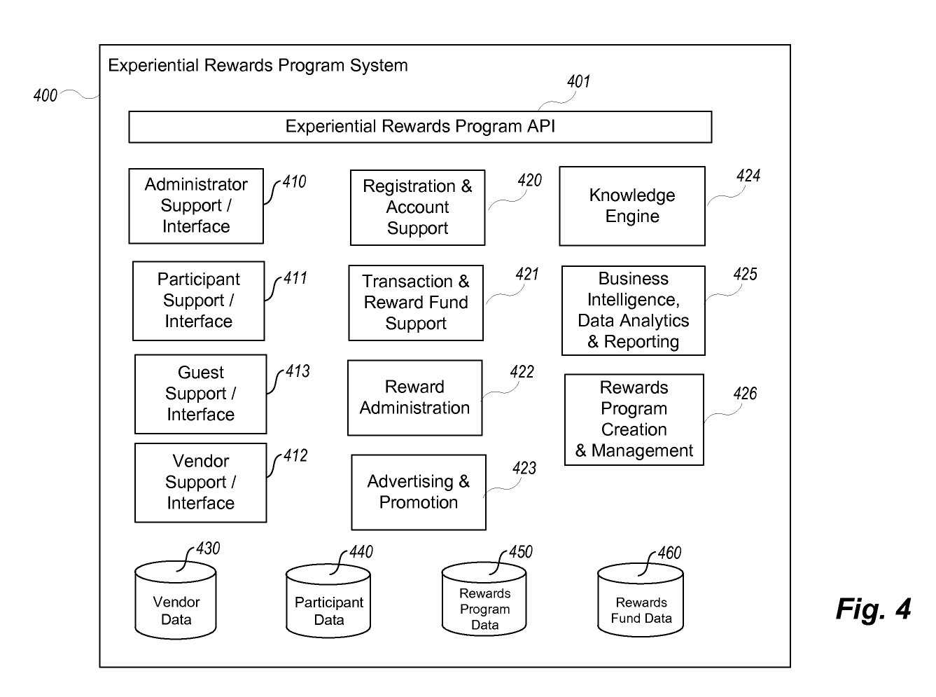

FIG. 4 is an example block diagram of the components of a system for practicing an experiential rewards program. Such a system may be used, for example, by an administer (such as ERPA 201 in FIG. 2) to administer an experiential rewards program such as uTANGO. Of note, the functions indicated as provided by the various blocks may be combined differently, and additional or different blocks may be provided in any particular instance of such a system. Experiential rewards program system 400 (“ERPS”) comprises an administrator support/interface module 410 (such as a web portal, or other user interface) for providing access to the system by administrators, a participant support/interface module 411 for providing access to the system by participants, a guest support/interface module 413 for providing access to the system by anonymous guests, a vendor support/interface module 412 for providing access to the system by vendors, and, in some embodiments, an application programming interface (an “API”) for providing programmatic access to the functional components, interfaces, and/or data maintained by the ERPS.

The ERPS also includes one or more data repositories 430, 440, 450 and 460 for generating and maintaining vendor, participant, rewards program related, and rewards fund data, respectively. Anonymous guest transactions are associated directly or indirectly with participants, for example by associating anonymous guest transaction information with participant data 440. These data repositories may include other demographic, statistical, or analytic data as desired. The data repositories may comprise data stored electronically in one or more data bases, files, tables, or any equivalent data storage structure.

The ERPS also provides various capabilities for manipulating the data stored in repositories 430, 440, 450, and 460 and for handling requests from the various interfaces 401 and 410-413. For example, in FIG. 4, the ERPS is shown as including registration and account support 420, e.g., for managing participant and vendor registrations; transaction and reward fund support 421, e.g., for tracking participant and associated guest purchases, commission payments, etc.; reward administration 422, e.g., for handling the payout of rewards to participants; advertising and promotion support 423, e.g., for serving ads that promote a coalition of the vendors; a knowledge engine 424, e.g., for advanced handling of customer relations management (“CRM”) activity, including a helpdesk; business intelligence, data analytics and reporting capabilities 425, e.g., for providing statistical analyses of the participant related data for one or more of the vendors, including predictive statistical models that may be used by a vendor to define offers; and experiential rewards creation and management capabilities 426, e.g., to allow administrators to create rewards programs with defined levels of participation, defined awards, etc. Other modules and functions can be incorporated similarly.

In some embodiments, the data stored in one of the repositories 430, 440, 450, or 460 may be incorporated into one of the other components of the system. For example, the data pertaining to a rewards program may be incorporated into knowledge engine 424.

In one embodiment, the knowledge engine 424 combines state of the art CRM technology, real-time customer care solutions, and a permission-based email platform to deliver a highly dynamic, very reliable, knowledge engine. Such a knowledge engine allows participants to quickly and easily access information for a particular rewards program and thereby reduces customer service challenges for the administrator. Administrators can manage participant growth more efficiently by having the knowledge engine available to provide “intelligent” customer assistance and can analyze and sort information so that the most popular and useful answers will be at the top of the list of knowledge items. Accordingly, participants are able to find answers to questions immediately, minimizing their need to telephone or email the administrator.

The business intelligence, data analytics and reporting capabilities 425 provides data analysis and reports to vendors. In some implementations of an ERP system, the data analytics and reporting capabilities 425 are accessed by vendors using a vendor support interface 412 implemented via a web portal. Analytics may target any type of data stored by an experiential rewards program, including participant related data and data specific to a planned or ongoing rewards program. Data analysis may be provided based on customer profile dimensions that allow vendors to drill down into historical data and projected purchase plans to learn more about customer trends and behavior patterns and to apply this learning to future messaging directed to participants, their guests, and customers. In one embodiment, the analytics are geared towards “power” users looking for reporting and return-on-investment (“ROI”) analysis that goes beyond the standard reporting offered by typical stand-alone CRM systems. The reporting capabilities are provided by reporting tools that allow vendors to slice and dice participant related data to view different dimensions, allowing vendors to isolate and analyze specific customer groups based on pre-determined attributes. Data can be organized and viewed according to what makes the most sense for the vendor's business, such as by product, seasons, or customer group.

Analytics for analyzing one or more aspects of a rewards program may be tailored to the vendors' needs by creating a “data-mart” that can be loaded with historical online and offline participant and customer profile data and projected purchase data. Participant and customer profiles can be set up to include broad categories, such as gender and geographic location, or they can be very specific around purchasing patterns and past “click-through” behavior. In addition, although guests purchasing on behalf of participants are anonymous to the system, some information can be tracked and gleaned from their purchase behavior, even if it doesn't provide private information such as the gender or address of the guest.

Vendors can take advantage of the data relating to a rewards program via new subsets of business data analysis, loyalty analytics, and using advanced, analytical capabilities and new database marketing tools, such as those provided by embodiments of an ERPS to perform mission-critical, twenty-first century, marketing tasks such as: comparing ROI results to forecasts and determining the sensitivity associated with specific variables and recalibrating; measuring customer value in dynamic, ever-changing models; determining the appropriate marketing value proposition and the optimization of the funding rate to yield the greatest historical behavioral change; increasing incremental revenue, one customer at a time, defining specific marketing strategies for increasingly finite customer segments, modeling customer attrition and intervening prior to their departure; modeling cross-sell/up-sell potential, enabling a marketer to put their money where the impact is likely to be greatest; determining the net present value (NPV) of major marketing campaigns and initiatives; customer behavior profiling; customer lifecycle and demographic profiling; customer product preferences and repertoire; customer targeting and differentiation; best customer marketing and win-back; product category relationships and cross-selling; planning and merchandising; online shopping suggestions; and pricing policies.

By analyzing actual purchase behavior along with real-time participant feedback on future buying plans (for example, in the next three, six, and nine months), the business intelligence, data analytics, and reporting capabilities 425 can help vendors determine unique buying patterns of program participants. By adding program specific demographic and lifestyle data of participants, such as when participants intend to get married or when they were married, the program vendors can created specific offers tailored to the various life-stage events of each demographic and leverage their defined spending commitments to drive predictable, long-term, loyal spending behavior. For example, the vendors can create offers for the specific life-stage events of each new family that joins the offered reward program.

The stored data in conjunction with the business intelligence, data analytics, and reporting capabilities 425 can provide a very robust customer profile that provides vendors a complete view of the rewards program participant and delivers very robust analytics for future campaign and offer development. For example, closed-loop one-to-one targeted marketing technology can be used to receive advertising messages, coupons, and discount offers by participants from vendors, send wireless messages, coupons, and discount offers that are personalized, relevant, and anticipated to participants in the program; allow participants to redeem wireless coupons and discount offers at retail stores; capture purchasing events in real time; and update a knowledge database and notify vendors of cross- and up-sale opportunities. In addition, one-to-one e-messaging capabilities are provided to vendors their online customer management process of acquisition, cultivation, conversion, and retention, thus maximizing the customer lifetime value of each of the program participants by delivering participant lifecycle solutions tailored to their specific buying requests and habits. In addition, an experiential rewards program implemented by an ERPS provides an intention-based value network via a permission-based program where participants opt in to receive promotions; participants and consumers provide demographic and psychographic data; and participants and consumers provide personal interest and enthusiast data.

Artificial intelligence modeling can also be provided by the business intelligence, data analytics and reporting capabilities 425 to apply artificial intelligence techniques such as neural networks, decision trees, and statistical techniques to model consumer purchase behavior, to predict participant responses to different incentives, and to help vendors develop incentive programs to achieve marketing goals.

The knowledge that vendors gain from knowing their customers can be used in developing effective campaigns that build their own customer base not only within but also outside of the program and to yield an outstanding return on investment. For example, through relational database technology, a rewards program implemented using an ERPS can provide capabilities to link vendor proprietary data to program in-house prospecting data, giving vendors access to virtually every participant's household. Once the rewards program has cross-referenced the vendors' best prospects profile with the reward program participant data, the program can develop and execute highly successfully customer acquisition campaigns. Services that may be provided by an ERPS in this regard include for example the development, execution and reporting of direct email campaigns, and response tracking and reporting.

An experiential rewards program can provide capabilities to quantify total customer value using its ability to link multiple channels (store, catalog, web, cell-phone). Vendors can be provided with an in-depth, 360-degree view of their customer across all channels, which drives effective marketing and loyalty programs and equips spenders with true decision-making power. The business analytics thus provided include multi-dimensional customer profiling, customer models/profiling-custom built to predict response to other customer behavior, customer recognition and identification system, statistical consulting, advanced segmentation development, customer and business analysis and modeling, and advanced campaign analysis, etc.

Other statistical modeling, business, and data analytics may be provided by and incorporated within a particular embodiment of an ERPS to equip rewards programs as needed, including modeling and analytics not yet conceived.

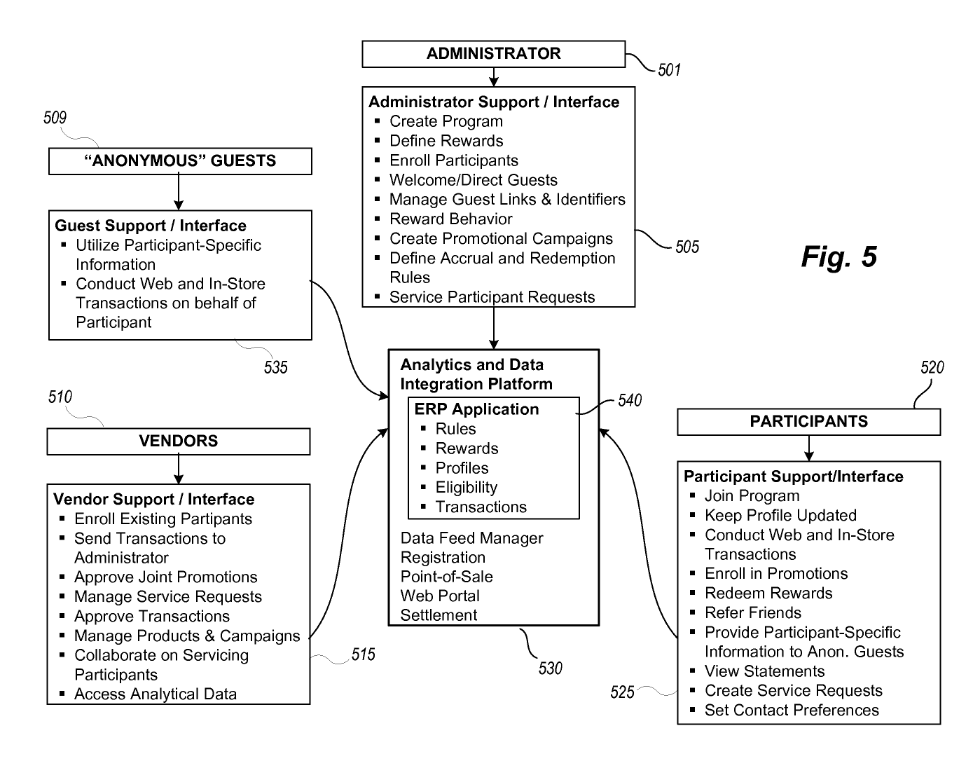

FIG. 5 is an example diagram illustrating some of the functions that can be made available to reward programs by one example embodiment of an experiential rewards program system. The diagram presents many of the same capabilities of the system illustrated in FIG. 4, but from a functional perspective. It demonstrates how a system may be configured to support the activities of an administrator 501, participants 520, anonymous guests 509, and vendors 510.

Specifically, the administrator support/interface 505 provides functions, for example through an administrator “portal,” which allows an administrator 501 to manage a reward program. These functions may include, but are not limited to, creating multiple reward programs, defining tiers within the programs, qualifying and enrolling participants, welcoming and/or directing anonymous guests, managing links and browser identifiers (e.g., client application “cookies” and session information) for anonymous shoppers, rewarding behavior, creating targeted promotional campaigns, defining accrual and redemption rules, and servicing participant requests. A portal may be provided, for example, by means of a traditional monolithic graphical user interface, an interface provided by a computing system that also provides the back end support, or a client module, device, web browser, or other application configured to interface to back end ERPS capabilities through a network, such as the Internet.

The participant support/interface 525 provides functions, for example through a participant portal, which allows participants 520 to engage in a variety of activities, including, but not limited to, joining a program, keeping a profile up to date, conducting web and in-store transactions, enrolling in promotions, redeeming rewards, referring friends for registration with the program, providing participant-specific information to anonymous guests 509, viewing statements, creating service requests, and setting contact preferences.

The guest support/interface 535 provides functions, for example through a guest portal or via any client application or web browser, which allows guests 509 to engage in a variety of activities, including, but not limited to, utilizing the participant-specific information provided by participants 520, and conducting web and in-store transactions.

The vendor support/interface 515 provides functions, for example through a vendor portal, which allows vendors 510 to engage in a variety of activities that include, but are not limited to, enrolling existing participants, sending transactions to a host organization, approving joint promotions, managing service requests, approving transactions, managing products and campaigns, collaborating on servicing participants, and accessing analytical data.

The analytics and data integration platform 530 represents the “back end” capabilities supported by an example ERPS. The ERP Application 540 provides many of the capabilities shown in the blocks of FIG. 4, including, for example, support for defining and managing program rules, rewards, tiers, profiles, and eligibility, and transaction management. The ERP Application 540 may be configured as, for example, a software application, module, or web service having data and instructions to support the functions accessed by the vendors 510, participants 520, guests 509, and administrator 501, through their respective interfaces 515, 525, 535, and 505. The ERP Application 540 may also be configured as hardware or firmware. The platform 530 also includes the ability to perform enterprise level analytics and data integration to support functions such as registration, point of sale activities, web activities, data feeds, billing, settlement, and other functions.

The infrastructure provided by the analytics and data integration platform 530 allows the administrator 501 to quickly develop data repositories to meet vendor business objectives, access participant data with sophisticated computer-based query tools via the Internet or other standard or proprietary communication lines. Vendors can quickly gain the type of customer insight that fuels their ability to reach customers and drive more frequent and sustained purchasing habits, not only from program participants but from outside customers.

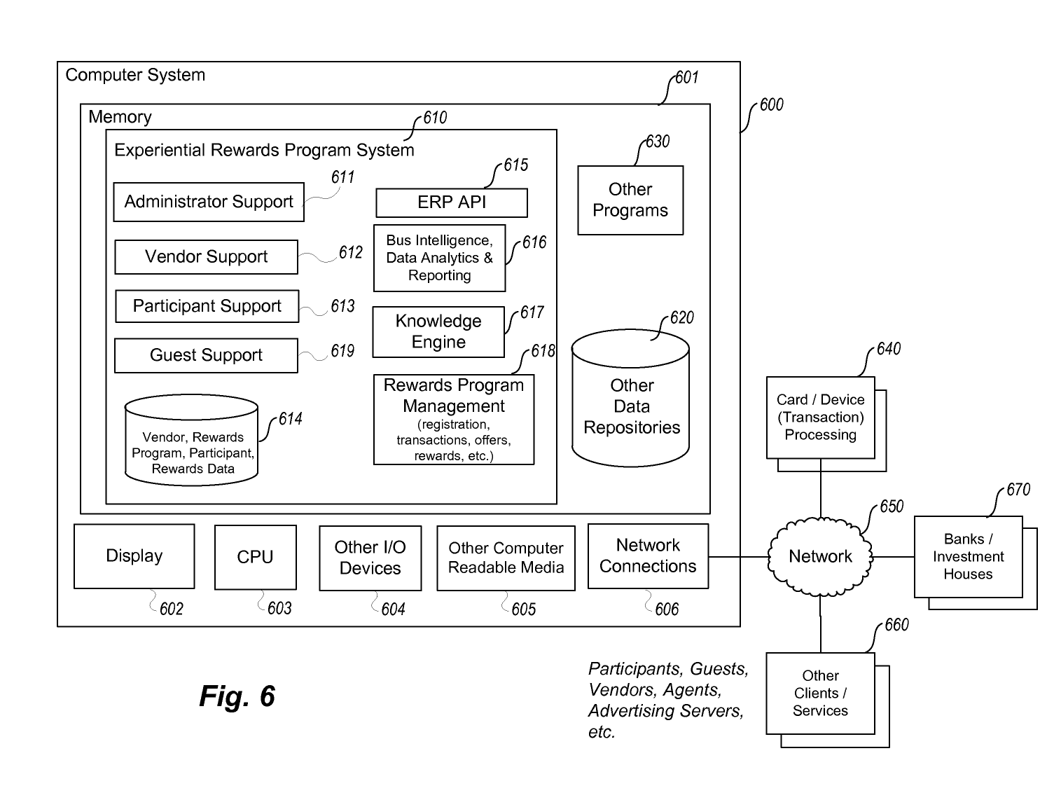

FIG. 6 is an example block diagram of a computing system for practicing embodiments of an Experiential Rewards Program System. Note that a general purpose or a special purpose computing system may be used to implement one or more of the components of an “ERPS”. The general purpose computer system 600 may comprise one or more server and/or client computing systems and may span distributed locations. In addition, each block shown may represent one or more such blocks as appropriate to a specific embodiment or may be combined with other blocks. Moreover, the various blocks of the Experiential Rewards Program System 610 may physically reside on one or more machines, which use standard (e.g., TCP/IP) or proprietary interprocess communication mechanisms to communicate with each other. Also one or more components may be implemented by software, hardware, firmware, or some combination thereof.

In the embodiment shown, computer system 600 comprises a computer memory (“memory”) 601, one or more displays 602, one or more Central Processing Units (“CPU”) 603, one or more Input/Output devices 604 (e.g., keyboard, mouse, CRT or LCD display, etc.), other computer-readable media 605, and one or more network connections 606. The Experiential Rewards Program System (“ERPS”) 610 is shown residing in memory 601. In other embodiments, some portion of the contents, some of, or all of the components of the ERPS 610 may be stored on or transmitted over the other computer-readable media 605. The components of the Experiential Rewards Program System 610 preferably execute on one or more CPUs 603 and manage the generation and use of loyalty and rewards programs, as described in previous figures. Other downloaded code or programs 630 and potentially other data repositories, such as data repository 620, also reside in the memory 610, and preferably execute on one or more CPUs 603. Of note, one or more of the components in FIG. 6 may not be present in any specific implementation. For example, some embodiments embedded in other software many not provide means for user input or display.

In a typical embodiment, the ERPS 610 includes one or more modules/components 611-619, for example, those as described in FIG. 4. The ERPS may interact with other systems, devices, or services, such as client applications, browsers, or other services 660, transaction processing systems 640, and banks or investments services 670, etc. via a network 650 as described below.

In an example embodiment, components/modules of the ERPS 610 are implemented using standard programming techniques. However, a range of programming languages known in the art may be employed for implementing such example embodiments, including representative implementations of various programming language paradigms, including but not limited to, object-oriented (e.g., Java, C++, C#, Smalltalk, etc.), functional (e.g., ML, Lisp, Scheme, etc.), procedural (e.g., C, Pascal, Ada, Modula, etc.), scripting (e.g., Perl, Ruby, Python, JavaScript, VBScript, etc.), declarative (e.g., SQL, Prolog, etc.), etc.

The embodiments described above use well-known or proprietary synchronous or asynchronous client-server computing techniques. However, the various components may be implemented more monolithic programming techniques as well, for example, an executable running on a single CPU computer system, or alternately arranged using a variety of structuring techniques known in the art, including but not limited to, multiprogramming, multithreading, client-server, or peer-to-peer, running on one or more computer systems each having one or more any of CPUs. Some embodiments are illustrated as executing concurrently and asynchronously and communicating using message passing techniques. Equivalent synchronous embodiments are also supported by an ERPS implementation.

In addition, programming interfaces to the data stored as part of the ERPS (e.g., in the data repositories 614) can be available by standard means such as through C, C++, C#, and Java APIs; libraries for accessing files, databases, or other data repositories; through scripting languages such as XML; or through Web servers, FTP servers, or other types of servers providing access to stored data. The vendor, rewards program, participant, and rewards data 614 may be implemented as one or more database systems, file systems, or any other method known in the art for storing such information, or any combination of the above, including implementation using distributed computing techniques. In addition, the various functions, such as the business intelligence and other data analytics, may be implemented as stored procedures, or methods attached to participant, vendor, function, reward, etc. “objects,” although other techniques are equally effective.

Also the example ERPS 610 may be implemented in a distributed environment that is comprised of multiple, even heterogeneous, computer systems and networks. For example, in one embodiment, the administrator support 611, the knowledge engine 617, and the ERPS data repository 614 are all located in physically different computer systems. In another embodiment, various components of the ERPS 610 are hosted each on a separate server machine and may be remotely located from the tables which are stored in the ERPS data repository 614. Also, one or more of the components may themselves be distributed, pooled or otherwise grouped, such as for load balancing, reliability or security reasons. Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.), etc. Other variations are possible. Also, other functionality could be provided by each component/module, or existing functionality could be distributed amongst the components/modules in different ways, yet still achieve the functions of an ERPS 610.

Furthermore, in some embodiments, some or all of the components of the ERPS 610 may be implemented or provided in other manners, such as at least partially in firmware and/or hardware, including, but not limited to one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the system components and/or data structures may also be stored (e.g., as software instructions or structured data) on a computer-readable medium, such as a hard disk, a memory, a network, or a portable media article to be read by an appropriate drive or via an appropriate connection. The system components and data structures may also be transmitted via generated data signals (e.g., as part of a carrier wave or other analog or digital propagated signal) on a variety of computer-readable transmission mediums, such as media 605, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

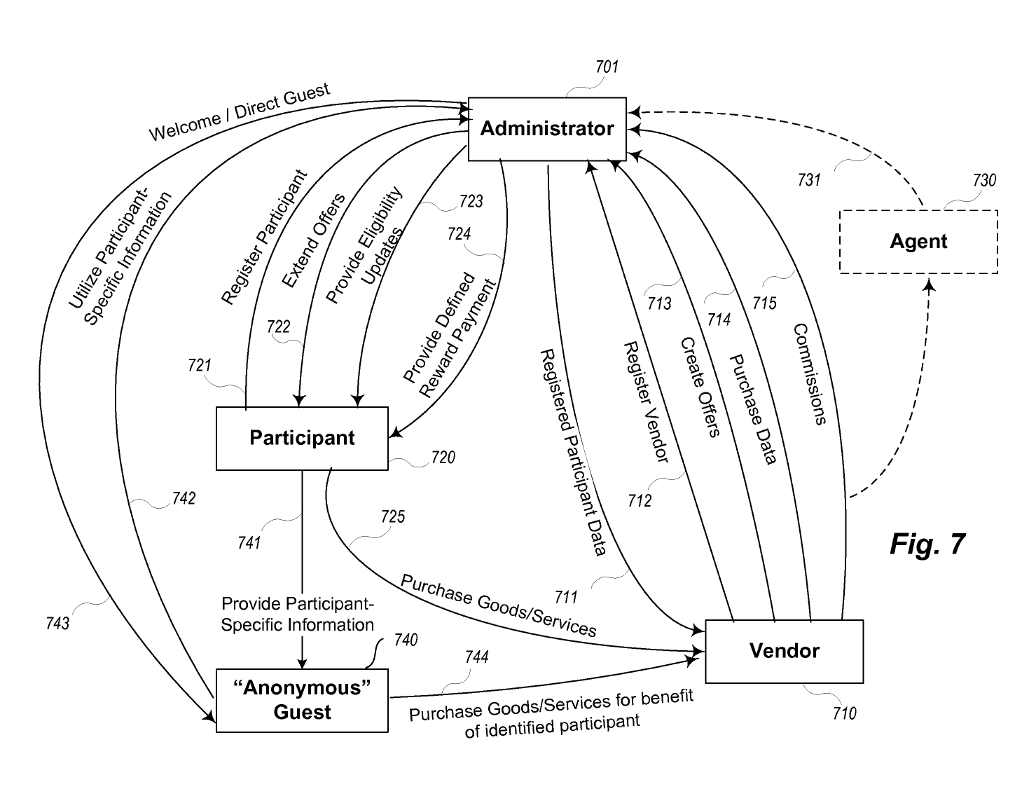

FIG. 7 is an example block diagram that illustrates the activities that can occur between an administrator, participants, guests, and vendors in an experiential reward program, such as one configured to implement life-stage rewards for married couples. The relationships among an administrator 701, participant 720, anonymous guest 740, and vendor 710 in terms of their various activities is illustrated. The various activities (events) 711-715, 721-725, 741-743, and 731 can occur separately, in parallel, concurrently, or at other defined times and in different orders than those described.

Events 711-715 describe the interactions of vendors 710 with an administrator 701 of an example rewards program. In event 712, the vendor 710 registers itself through the administrator 701 to be part of a rewards program, such as uTANGO. In return, in event 711, the administrator 701 provides the vendor 710 with registered participant information or data. In event 713, the vendors 710 then create offers that are transmitted through (or initiated by) the administrator 701 to the participants 108. These offers may be created using analytical tools and modeling provided by a computing system accessible to the vendor 710 once the vendor has registered. As participants 720 purchase goods and services from vendors (event 725) and as guests such as anonymous guest 740 purchase goods and services on behalf of a participant (event 744), purchase data is sent in event 714 from the vendors 710 to the administrator 701. Further, in accordance with agreements between the administrator 701 and the vendors 710, in event 715 the vendors 710 pay commissions to the administrator 701 based at least in part on the purchases made by the participants 720 and their associated guests 740. Commissions can also be based upon other data provided to the vendors 710 by the administrator 701, advertising services, and other agreed-upon services provided by the administrator 701. Optionally, an agent person or system 730 can be used as an intermediary between the vendor 710 and the administrator 701 to exchange commissions (event 731) or other information. Such agents 730 can include, but are not limited to, banks, transfer agents, and other settlement means of financial institutions.

Events 721-724 describe the interactions of participants 720 with an administrator 701 of an example rewards program. In event 721, participants 720 interact with an administrator 701 or the particular rewards program, such as uTANGO, to register a participant 720 in the program. In events 722 and 723, the administrator 701 provides offers to the participants 720, along with eligibility updates. The offers are typically based upon the offers created by vendors 710 in event 713. When a participant 720 becomes eligible for a reward, then in event 724 a defined reward payment is provided to the eligible participant 720 from or under the direction of the administrator 701. In addition, the administrator 701 causes tokenized links to be provided (through events not shown) to a participant 720, which optionally can be forwarded by the participant 720 to a desired guest 740 to allow the guest to make purchases and other transactions on behalf of the participant 720. Accordingly, a participant 720 may then be rewarded by the administrator 701 not only on the basis of their own transactions with vendors 710, but also on the basis of transactions between the anonymous guest 740 and the vendors 710.

Events 741-744 describe the interactions of anonymous guests 740 with a participant 720 and with an administrator 701 of an example rewards program. More specifically, after a participant 720 has registered, as mentioned the participant receives links (e.g., URLs with tokens identifying the participant 720) with participant identifying information, which can be optionally provided (event 741) to a guest of the participant. They rewards system is then able (through the token) to track purchases and other activities (event 744) of the anonymous guest 740 as being “a guest of” the participant 720. The guest 740 is associated (event 742) with the identified participant-specific information for tracking and analysis purposes. In some scenarios, the administrator 701 directs and welcomes the guest 740 (event 743), for example, to allow the guest to select a participant on whose behalf purchases will be made. Event 743 thus allows a single guest 740 to make purchases on behalf of several different participants. Such capabilities may be useful, for example, to buy gifts for multiple friends or family members.

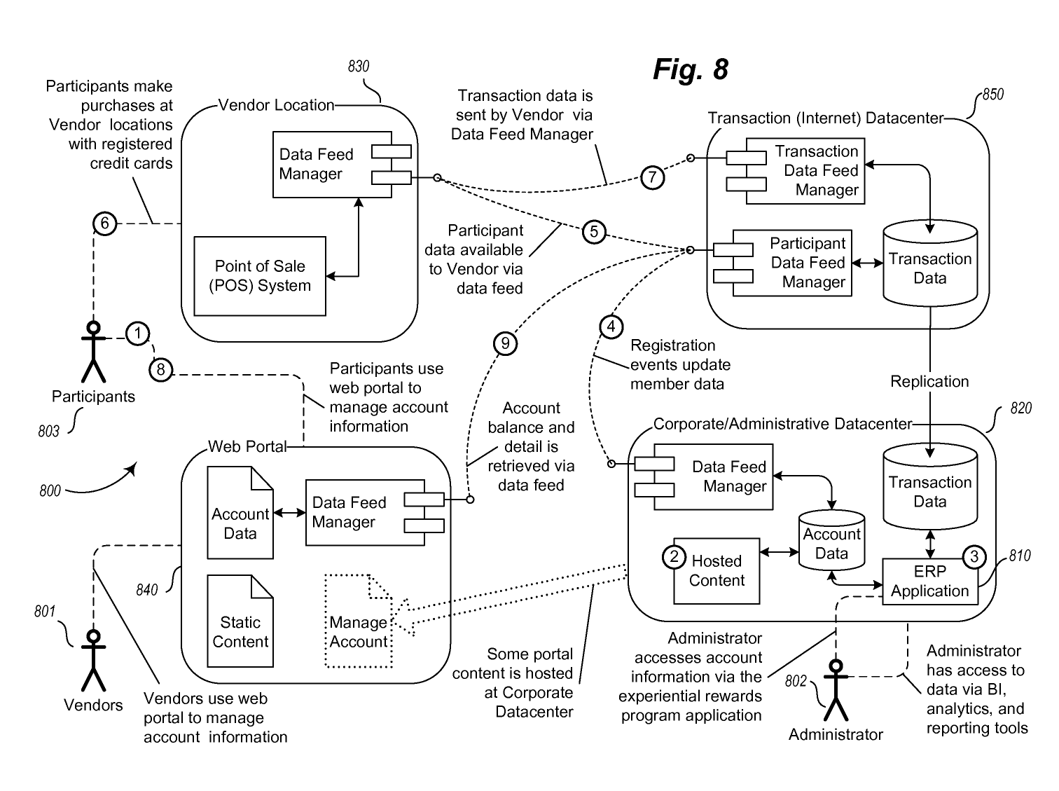

FIG. 8 is an example block diagram of a computing system architecture for implementing an experiential rewards program. The illustrated architecture 800 can be used to implement the methods, systems, and techniques described in the previous figures, and can be configured to implement a life-stage rewards program for married couples, such as that provided by uTANGO. In one embodiment, the architecture 800 is utilized by one or more administrators 802, one or more participants 803, and one or more vendors 801, preferably via a communications network such as the Internet.

According to one embodiment of the architecture 800, a network connects at least one web portal 804, one or more vendor locations 830, an Internet datacenter 850 (or equivalent transaction tracking system over the network), and an administration/corporate datacenter 820 (or equivalent), which supports the data accessible to one or more administrators 802. A participant 803 and a vendor 801 can use the web portal 840 to access and to manage account information, such as the participant's account relating to a particular vendor. Some of the account information may be hosted separately in the system accessible to the administrator 802, for example the datacenter 820. Other information, such as the balance available in the account or associated with a loyalty, debit, or credit card, may be updated by the transaction datacenter 850, as transactions are processed. A third party service/application may be used to host the data and to provide the management of the accounts by serving web pages to the web portal 840 as needed to manage the accounts and/or card registration.

The administrator 802 interfaces to the administration/corporate datacenter 820 through an experiential rewards program (ERP) application 810. The ERP application 810 allows the administrator 802 to access vendor and participant account related information, transaction data, and supports the business intelligence, data analytics, and reporting tools.

The transaction data resident in the administration/corporate datacenter 820 is kept up to date by the transaction (Internet) datacenter 850. For example, it may be an automatically replicated database, which is updated whenever transactions occur or at other times. The account data in the administration/corporate datacenter 820 is also kept up to date by the transaction (Internet) datacenter 850. Account registration changes initiated at the web portal 840 are fed to the transaction datacenter 850, which are then reported to and/or replicated in the administration/corporate datacenter 820, potentially automatically.

In some configurations of the example architecture 800, the administration/corporate datacenter 820 may be comprised of multiple systems and third party applications, which individually provide some aspect of the capabilities of the ERP application. For example, a third party system may be used to provide and served hosted pages and data for the web portal. Another third party system may be used to provide a data analytics engine that integrates with the account and vendor data to provide business intelligence and data analytics to the administrator 802.

When a transaction occurs, such as at a point of sale system of a vendor location 830, transaction data is sent (potentially automatically) to the transaction (Internet) datacenter 850. This data is then stored and replicated as appropriate throughout the rest of the architecture 800. A vendor location 830 may be a physical location such as a store or a vendor website. As needed, a system (such as a point of sale system) at the vendor location 830 may request participant related data from the transaction datacenter 850.

Although not shown in this figure, guests also can perform transactions at a vendor website on behalf of a participant. Such data is automatically associated with the identified participant, as described further below, and is sent to the transaction datacenter 850 and replicated throughout the rest of the architecture 800 as appropriate.

As shown, it is contemplated that at least a portion of the data can be transferred and shared automatically by the various systems 830, 840, 850, and 820 using various single and bi-directionally communications as appropriate. The “data feed manager” present in these system refers to any means for sending and receiving data as appropriate to the encompassing system, including but not limited to API, web service, and database transaction processing.

FIG. 9 is an example block diagram of a computing system architecture for tracking and servicing anonymous guest shoppers. For example, such tracking and servicing may be, but need not be, used as part of a loyalty reward program such as an experiential rewards program. As described earlier, guests can make purchases from the program vendors to benefit one or more participants. These guests can be anonymous and can make purchases without the need to register themselves or their personal information with the system. Events labeled 1-10 illustrate how the various components of the architecture interact to achieve anonymous guest shopping in an example scenario where guests of participant A shop with Vendor Z on behalf of participant A. The capabilities shown can be modified as appropriate to provide other types of attribution of anonymous guest activities and behaviors using the tokenized link techniques described herein.

In particular, to enable anonymous guest shopping, a rewards program administrator (such as administrator 102 in FIG. 8) or other entity generates information specific to a particular registered participant. For example, but without limitation, the administrator may generate a participant-identifying link, such as a tokenized URI or URL specific for that participant. A tokenized URL is a Unified Resource Locator that includes a unique character string associated with the registered participant, which can be forwarded automatically each time the URL is used to access a web page (for example, through a link redirect). This code can be an account identifier for the registered participant or could be more granular to associate the generation of the code at a point in time, or generated as a result of a particular participant behavior, or both. For example, a URL such as:

“www.utango.com/proc/g/?merchantID=H352-G2DH3A&participantID=FHD902JD-123”

may be used to identify both a qualifying merchant and the associated participant.

In event 1, an administrator, through administrator server 974, makes this tokenized link (or other structure) available to the participant, for example, by sending a personalized participant promotional email from the administrator that includes a range of shopping advertisements and special discount offers. Such distribution may occur, for example, when the participant has completed registration, when a new vendor is added to the rewards program, or at other times. One or more links associated with the same vendor or with different vendors or circumstances (such as reflecting discounts or coupons) may be generated and distributed to the participant. An administrator can generate numerous unique tokens for the tokenized URLs for each registered participant to enable more granular tracking overtime of the distribution of tokenized URLs.

In one embodiment, each of the links in the promotional email is configured to point to one or more administrator servers, where the underlying destination URL (such as to a vendor website) is mapped to the tokenized URL. These tokenized URLs may also contain destination URL tokens as well as registered participant associated tokens as described. Thus, tokenized URLs can serve both as identifiers of the participant as well as potential guest shopping links directly selectable by a guest.

In the example shown in FIG. 9, the email contains a special sale from Vendor Z. For this example, it is assumed (although not necessary) that Vendor Z is registered in an existing affiliate marketing network 976; however, other configurations, such as connection through one or more intermediate servers (advertisers or other publishers) or directly to Vendor Z's website or server could be supported. An affiliate marketing network typically includes a network of advertiser computing systems and publisher of advertisements computing systems electronically connected via a communications network to promote the desired actions of the advertisers (e.g., on behalf of merchants) or merchants themselves and to deliver economic benefits to the publishers for their successes. The publisher computing systems are sometimes referred to as “affiliates,” of, for example, advertisers such as Vendor Z (or the merchants or companies Vendor Z services). In this example, the experiential rewards program administrator server 974 is serving as a publisher of Vendor Z, and can take advantage of existing techniques for forwarding, redirecting, tracking, and receiving commissions based upon tokenized links.

In event 2, the registered participant can make a tokenized link available to any number of guests, thereby allowing them to make purchases on behalf of the registered participant anonymously. For example, the participant may e-mail the tokenized link to the participant's friends and family. As another example, the tokenized link may be embedded in a personal web page of the participant. Other known means of providing a link such as a tokenized URL can be similarly incorporated.

Anonymous guests activate the tokenized link through use of a tracking device. A tracking device is a tool, application, module, or device capable of generating a unique device identifier as well as (optionally) the ability to retain tracking codes such as cookies. A web-based computer browser is one example of a tracking device. Other devices, including but not limited to, mobile communications devices, are also contemplated for use with an experiential rewards program environment, as described herein.

More particularly, in event 3, upon clicking on the tokenized URL (for example, as shown for Vendor Z), the guest is forwarded to a web page indicated by the link. (Typically, a client application, e.g., a web browser, is invoked to cause a web page to be loaded onto the guest tracking device 970 as a result of accessing the link.) In some embodiments, the guest is immediately forwarded to the Vendor Z destination address (e.g., through a URL that points to the vendor z web site 978), and purchases and tracking take place as with typical affiliate network and redirection mechanisms. In other embodiments, the link causes the guest to be forwarded to a web page on the administrator site 972 (served, for example, by administrator server 974).

In the example shown in FIG. 9, the guest who selects (event 3) the tokenized URL for participant A is forwarded to a landing web page to identify the registered participant account on whose behalf the guests' behavior will be attributed. At this point, the guest is welcomed as the ‘Guest of registered participant A.’ Upon clarifying that any activity will go to registered participant A's account, the guest is presented with an option to proceed, to create their own registered account with the administrator, or to login to identify themselves as a registered participant.

When each of the anonymous guests clicks on the tokenized link provided by participant A, each one of their tracking devices 970 contacts the administrator server 974 (optionally through the administrator site 972), because of the immediate destination address provided in the link. Preferably, the tracking device 970 forwards any existing state (such as web browser “cookies” or other state) information intended for the administrator. Such state information may be used to indicate whether a tracking device 970 has been registered and is associated with a registered participant.

In event 4, the state information (e.g., the forwarded “cookie”) is forwarded to the administrator server 974 to determine whether the tokenized link is associated with participant A or not. If the forwarded state information identifies the tracking device 970 as one that was last utilized by registered participant A, and the tokenized link is associated with registered participant A, then the visitor is assumed to be registered participant A and not a ‘Guest of Participant A.’ The access to Vendor Z is then handled as with all accesses for a recognized registered participant.

If, on the other hand, the forwarded state information identifies the tracking device 970 as one that was not utilized by a registered participant A, and the tokenized link is associated with registered participant A, the visitor is considered to be an anonymous guest. In this case, the administrator server 974 determines that there is no state information to indicate that tracking device 970 is associated with registered participant A. Therefore, tracking device 970 is presumed to belong to an anonymous guest of registered participant A.

In event 5, each anonymous guest is associated with a session identifier (e.g., a Session ID) unique to their tracking device at that point in time, and a cookie (or other state information) is passed to the guest's tracking device 970 for subsequent identification of administrator server 974 interactions. For example, in FIG. 9, the guest is assigned a session identifier of “Guest” and optionally has a cookie (or other state information) set on their tracking device 970 that identifies them as an anonymous guest of registered participant A.

In one embodiment, the guest tracking device 970 will continue to be identified by the administrator server 974 as an anonymous guest of registered participant A, until any of the following occur:

1) the tracking device cookie (or other state information) for the administrator server 974 is deleted;

2) the tracking device user identifies him or herself as a registered participant by, for example, logging in with appropriate participant credentials;

3) the tracking device user creates a new account and becomes a registered participant; or

4) the tracking device user clicks on a guest shopping link for a distinct registered participant, at which point the tracking device state information will be reset to be associated with the current identified participant. Accordingly, a guest who has retained the tokenized links from multiple registered participants could switch back and forth with which registered participant they are currently associated. For example, a father may wish to rotate monthly which son on whose behalf he is guest shopping.

Once an anonymous guest's tracking device 970 is associated with a registered participant as an anonymous guest, then the guest can commence shopping through affiliated vendor websites without requiring any further identification or registration. In some embodiments, all of the tracking is done through tracking device cookies. In other embodiments, cookies are not employed. At this point any activity of the anonymous guest on the administrator site 972 or any affiliated site that supports user tracking mechanisms can be attributed back to the registered participant's account.

It is possible that a registered participant who clicks on one of his participant tokenized URLs from a previously-unknown tracking device could be misidentified as an anonymous guest of himself. In that case, the participant's account would still get any transaction credit resulting from his own purchase behavior.

In one embodiment, anonymous guests are issued globally-unique Session IDs based on their tracking device initiating contact with the administrator servers 974. These Session IDs may be identical to the Session IDs issued to registered participants. Whereas registered participants may have Session IDs attached to their participant account identifier in a session database table managed by an administrator server 974, their anonymous guests may have their Session IDs attached to the (same) participant account identifier in the same table. A session type of “Guest Session” can be used to distinguish the session associated with an anonymous guest from the recognized session of the registered participant.

If the anonymous guest then clicks on affiliate advertising URLs that are configured to embed another session ID for tracking purposes, then the guest Session ID is passed along through the existing affiliate advertising tracking network. Known affiliate tracking techniques be may used to piggyback these session IDs.

Using standard affiliate tracking mechanisms (e.g., triggered through the use of affiliate network cookies), the anonymous guest may perform activities that result in economic benefits to the administrator server 974, such as commerce transactions, commissionable transactions, commissionable page views/clicks, commissionable registrations/sales leads, or any other contractually defined economic benefit to the administrator server 974 resulting from the anonymous guest behavior.

The rewards program administrator through administrator server 974 is able to attribute the anonymous guest behavior back to the registered participant account. This may result in benefits for the registered participant across a range of methods including, but not limited to, monetary compensation, loyalty reward points, access to special media or content, or other perquisites of value to the registered participant.

More specifically, in the example illustrated in FIG. 9, during event 6, the guests proceed to Vendor Z's website 978 and each place an order for $100 of merchandise. In this example, Vendor Z has established an affiliate contract of which the administrator server 974 is a participant (e.g., as a publisher). Hence, the affiliate network 976 automatically relays the guests to the Vendor Z site using the destination URL information provided in the URLs transmitted to it by administrator server 974.

In event 7, Vendor Z fulfills the guest orders and pays a 4% commission for each these transactions, resulting in three $4 payments to the administrator server 972, for a total of $12 in transaction commissions. The relay, tracking, billing, and accounting associated with such commissions can be handled by affiliate network provided mechanisms.

More specifically, in event 8, vendor server 980 sends each transaction record back through the affiliate network 976 and returns the Session ID previously forwarded by the administrator server 974 in the relay URLs. In event 9, using the returned unique Session IDs, the administrator server 974 can identify the tracking device 970 associated with each the Session ID, and the relationship of all three tracking devices 970 to registered participant A. Thus, the transaction details can be associated with registered participant A and commissions earned accrue to the benefit of participant A.

For example, if the administrator server 974 credits 50% of the commission amount to registered participants for qualifying activities, registered participant A receives, in event 10, $2 for each associated guest purchase for a total of $6 from the guest shopping activities of his relatives and friends. All that was required to establish the account linkage was for the anonymous guests to click on the tokenized link associated with the registered participant.

So long as vendor server 980 honors the Session ID established when the participant's guests initially visited Vendor Z's site, it is further possible for registered participant A to continue to receive commission receipts associated with participant A's account from subsequent Vendor Z purchases placed by these same guests.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 60/817,937, entitled “SYSTEM AND METHOD OF REWARDING SPENDING AND LOYALTY,” filed Jun. 30, 2006; U.S. Provisional Patent Application No. 60/915,016, entitled “SYSTEM AND METHOD OF REWARDING REGISTERED PARTICIPANTS FOR ACTIVITES OF UNREGISTERED GUEST SHOPPERS,” filed Apr. 30, 2007; U.S. patent application Ser. No. 11/772,033, entitled “SYSTEM AND METHOD OF REWARDING SPENDING AND LOYALTY,” filed Jun. 29, 2007, are incorporated herein by reference, in their entirety.

From the foregoing it will be appreciated that, although specific embodiments have been described herein for purposes of illustration, various modifications may be made without deviating from the spirit and scope of the present disclosure. For example, the methods, systems, and techniques for providing experiential rewards discussed herein are applicable to other architectures other than a client-server, or web based architecture. Also, the methods and systems discussed herein are applicable to differing protocols, communication media (optical, wireless, cable, etc.) and devices (such as wireless handsets, electronic organizers, personal digital assistants, portable email machines, game machines, pagers, navigation devices such as GPS receivers, etc.).

1. A method in a computing system for tracking electronic activities, comprising:
obtaining an indication of a registered user; and
automatically tracking electronic activities of one or more unregistered guests and attributing them to the registered user by associating a tokenized link with the registered user, the tokenized link provided to and used by the unregistered guests to perform the electronic activities.

2. The method of claim 1 wherein the electronic activity is an online purchase of a good or service.

3. The method of claim 1 wherein the electronic activity is an e-commerce transaction.

4. The method of claim 1 wherein the unregistered guests are anonymous to the computing system.

5. The method of claim 1 wherein the unregistered guests do not provide any personally identifying information to the computing system.

6. The method of claim 1 wherein the tokenized link is a URI containing a parameter that can be associated with the registered user.

7. The method of claim 1 wherein the tokenized link is configured to provide a identifier of the registered user that is forwarded to at least one vendor from which purchases are made.

8. The method of claim 1, further comprising:
using the automatically tracked activities to administer a loyalty rewards program.

9. The method of claim 1, further comprising:
using the automatically tracked activities to pay a portion of received commissions to the registered user.

10. A computing system for tracking electronic commerce transactions, comprising:
a memory; and
a tracking module stored in the memory, configured when executed to:
provide one or more links to a registered user, each link containing a parameter that identifies the registered user;
receiving an indication of a link associated with a vendor web site from a tracking device; and
when the received link contains the parameter that identifies the registered user and the tracking device is not associated with the registered user, associating an anonymous guest with the registered user and the tracking device such that transactions made from the vendor web site using the tracking device are associated with the registered user.

11. The computing system of claim 10 wherein the one or more links are URIs containing a token that identifies the registered user.

12. The computing system of claim 10 provided as part of an affiliate network.

13. The computing system of claim 12 wherein the computing system is an affiliate publisher that advertises information regarding the vendor web site.

14. The computing system of claim 10 wherein a user that purchases from the vendor web site using the tracking device can make purchases on behalf of the registered user without registering and without providing personally identifying information.

15. The computing system of claim 10 wherein the tracking module is further configured, when executed, to:
provide compensation to the registered user based upon purchases made by the associated anonymous guest.

16. The computing system of claim 10 wherein the tracking module is further configured, when executed, to:
when the received link contains a parameter that identifies a new registered user and the tracking device is associated with the registered user, associating an anonymous guest with the new registered user such that transactions made from the vendor web site using the tracking device are associated with the new registered user.

17. The computing system of claim 10 wherein the tracking module is further configured, when executed, to:
present options to the anonymous guest associated with the tracking device to become a registered user, to perform transactions on behalf of a newly designated registered user, or to continue performing transactions on behalf of the registered user identified by the received link.

18. The computing system of claim 10 wherein the tracking module is further configured, when executed, to:
cause state information to be stored on the tracking device, the state information identifying the tracking device as being associated with the anonymous guest of the registered user.

19. A computer-readable medium containing content that controls a computing system to track electronic purchases, by performing a method comprising:
causing one or more tokenized URIs to be provided to one or more guests of a registered shopper, each URI identifying the registered shopper; and
automatically tracking electronic purchases made by the one or more guests by:
receiving an indication of a URI associated with a vendor web site;
determining from a token associated with the received URI a registered shopper identified by the received URI; and
attributing to the registered shopper identified by the received URI a purchase made from the vendor web site by the one or more guests.

20. The computer-readable medium of claim 19, the method further comprising:
rewarding the registered shopper based at least in part upon the attributed purchases.

21. The computer-readable medium of claim 19 wherein the guests are unregistered guests with respect to the computing system.

22. The computer-readable medium of claim 19 wherein the guests provide no personally identifying information to the computing system.

23. The computer-readable medium of claim 19, the method further comprising:
rewarding the registered shopper based at least in part upon a commission provided by the vendor web site.

24. The computer-readable medium of claim 19 wherein the computer-readable medium is at least one of a memory of the computing device or a data transmission medium transmitting a generated data signal containing the contents.

25. The computer-readable medium of claim 19 wherein the contents are instructions that, when executed, cause the computing device to perform the method.

26. A method in a computing system for administering rewards, comprising:
obtaining an indication of a financial spending commitment from a registered participant to purchase goods or services from at least one vendor over a designated period of time; and
determining whether the registered participant has met the indicated financial spending commitment based at least in part on tracking purchases made from the at least one vendor by one or more unregistered anonymous guests associated with the registered participant.

27. The method of claim 26, further comprising:
distributing a reward to the registered participant based at least in part on the purchases made from the at least one vendor by the one or more unregistered anonymous guests associated with the registered participant.

28. The method of claim 27 wherein the reward is based at least in part upon a commission received from the at least one vendor based at least in part on the purchases made by the one or more unregistered anonymous guests.

29. The method of claim 26, wherein the registered participant is a participant registered in a consumer loyalty program, and further comprising:
distributing a reward to the registered participant based at least in part on purchases made by from the at least one vendor associated with the consumer loyalty program by the one or more unregistered anonymous guests associated with the registered participant.

30. The method of claim 26 wherein the unregistered anonymous guest is not required to provide personally identifiable information in order to track purchases made by the guest.

31. The method of claim 26, further comprising:
providing a tokenized URI to be distributed to the one or more unregistered anonymous guests to identify the registered participant for tracking purchases made from the at least one vendor by the one or more unregistered anonymous guests.

32. The method of claim 31 wherein the tokenized URI is distributed to the one or more unregistered anonymous guests at the discretion of the registered participant identified by the tokenized URI.

33. The method of claim 26, the tracking the purchases made from the at least one vendor by the one or more unregistered anonymous guests associated with the registered participant, further comprising:
causing one or more links containing a token identifying the registered participant to be provided to the one or more unregistered anonymous guests;
receiving information from the at least one vendor following purchases made from the at least one vendor by the one or more unregistered anonymous guests, the received information including the token identifying the registered participant and purchase information; and
associating the received purchase information with the identified registered participant identified in the received token.

34. The method of claim 26, further comprising:
funding a rewards fund based at least in part upon a commission received from the at least one vendor based on the purchases made by the one or more unregistered anonymous guests.

35. The method of claim 26 wherein the registered participant is at least one of a newly married person, a person engaged to be married, or a single person.

36. A method for administering a loyalty rewards program, comprising:
registering a participant to participate in the reward program by purchasing goods or services from at least one vendor in exchange for rewards based at least in part upon the quantity or quality of purchases;
tracking purchases made from the at least one vendor by the registered participant; and
distributing rewards to the registered participant based at least in part on tracked purchases made by the registered participant and based at least in part on tracked purchases made from the at least one vendor by one or more unregistered guests associated with the registered participant.

37. The method of claim 36 wherein the unregistered guests are friends or family of the registered participant.

38. The method of claim 36 wherein the rewards are a portion of commissions earned from the at least one vendor for tracked purchases by the one or more unregistered guests.

39. A computer-readable medium containing content that controls a computing system to administer a consumer loyalty reward program, by performing a method comprising:
registering a participant to participate in the reward program by purchasing goods or services from at least one vendor in exchange for rewards based at least in part upon the quantity or quality of purchases;
tracking purchases made from the at least one vendor by the registered participant; and
distributing rewards to the registered participant based at least in part tracked purchases made by the registered participant and based at least in part on tracked purchases made from the at least one vendor by one or more unregistered guests associated with the registered participant.

40. The computer-readable medium of claim 39 wherein the unregistered guests are guests anonymous to the reward program.

41. The computer-readable medium of claim 39 wherein the distributing the rewards to the registered participant distributes rewards based at least in part on a commission provided by the at least one vendor.

42. The computer-readable medium of claim 29 wherein the computer-readable medium is at least one of a memory of the computing device or a data transmission medium transmitting a generated data signal containing the contents.

43. The computer-readable medium of claim 39 wherein the contents are instructions that, when executed, cause the computing device to perform the method.

44. A consumer loyalty program, comprising;
registering a participant in the consumer loyalty program to enable the tracking of participant purchases from one or more participating vendors towards rewards; and
automatically tracking electronic transactions made in conjunction with the one or more participating vendors by anonymous guests of the registered participant to enhance the eligibility of the registered participant to receive rewards based upon a characteristic of the automatically tracked electronic transactions.

45. The loyalty program of claim 44, wherein the automatically tracking electronic transactions by anonymous guests, further comprises:
automatically tracking a tokenized link provided to the anonymous guests, the link configured to identify the registered participant when electronic transactions are performed by the anonymous guests.

46. The loyalty program of claim 44 wherein the anonymous guests are not required to register with the loyalty program or provide personally identifiable information in order to perform electronic transactions attributable to the registered participant.

47. The method of claim 44, further comprising:
rewarding the registered participant based at least in part on the automatically tracked electronic transactions made by the anonymous guests.

48. The method of claim 44 wherein the characteristic of the automatically tracked electronic transactions is at least one of a quantity or a quality associated with goods and/or services.

49. The method of claim 44 wherein the electronic transactions comprise online purchases of goods or services.

50. The method of claim 44 wherein the electronic transactions comprise online activities that do not result in a purchase of a good or service.
